(19) United States
(12) Patent Application Publication
(10) Pub. No.: US 2019/0305360 A1
(43) Pub. Date: Oct. 3, 2019

(54) Single Fold Battery Design

(71) Applicant: Google LLC, Mountain View, CA (US)

(72) Inventors: Scott Duncan, Mountain View, CA (US); SeungJae Hong, Mountain View, CA (US); Chaozhen Deng, Changzhou Jiangsu (CN)

(21) Appl. No.: 15/943,300

(22) Filed: Apr. 2, 2018

(51) Int. Cl. H01M 10/058; H01M 10/04; H01M 2/10

(52) U.S. Cl. CPC H01M 10/058; H01M 2/1016; H01M 10/0431

(57) ABSTRACT

This disclosure relates to wrapped batteries and battery systems. An example wrapped battery includes an anode, a cathode, a separator, and an electrolyte packaged within a pouch. The pouch includes a polymer coated with a conductive material and at least one sealed and folded edge, which is folded in a single-side fold arrangement to form a battery. The battery is wrapped with a pack wrap to form the wrapped battery and cover exposed conductive material on the at least one sealed and folded edge. An example battery system includes a first battery arranged proximate to a second battery to form a combined battery configuration and wrapped with a pack wrap to form the battery system and to cover exposed conductive material in the sealed and folded edges. The wrapped battery and battery system do not include side tape over the exposed conductive material of the sealed and folded edges.

### BACKGROUND

Single-side folding processes for closing battery pouches are often preferred over double-side-folding processes because they are simpler processes and there is less impact on the integrity of the battery pack due to a thicker pouch. Conventional single-side folding processes may include the addition of side tape to prevent exposure of conductive material on the folds and improve battery safety. However, the use of the side tape can reduce the cell capacity a given overall battery volume.

An alternative to single-side folding is double-side folding, where the pouch edges are folded up and then over to prevent exposure of the conductive material layers. However, conventional double-side folding is a more complex closing process than single-side folding. In addition, double-side folding can increase at least one dimension of the battery pouch, reducing the usable battery volume, and thus reducing battery capacity. Accordingly, a need exists for a simple and safe battery pouch closing process that does not unduly reduce cell capacity.

### SUMMARY

Embodiments in the present disclosure relate to batteries and battery systems and methods of manufacturing batteries and battery systems. In example embodiments, the batteries and battery system do not include side tape over the exposed conductive material of sealed and folded edges.

In an aspect, a wrapped battery is provided. The wrapped battery includes an anode, a cathode, a separator, and an electrolyte. The wrapped battery also includes a pouch comprising a polymer coated with a conductive material and at least one sealed and folded edge. The anode, the cathode, the separator, and the electrolyte are packaged within the pouch. The at least one sealed and folded edge is folded in a single-side fold arrangement to form a battery, such that the at least one sealed and folded edge substantially conforms to at least a portion of a surface of the battery. The battery is wrapped with a pack wrap to form the wrapped battery and cover exposed conductive material on the at least one sealed and folded edge.

In an aspect a battery system is provided. The battery system includes a first battery. The first battery includes a first anode, a first cathode, a first separator, and a first electrolyte in a first pouch. The first pouch includes a polymer coated with a conductive material and at least a first sealed and folded edge. The at least a first sealed and folded edge is folded in a single-side fold arrangement such that the at least a first sealed and folded edge substantially conforms to at least a portion of one surface of the first battery. The battery system also includes a second battery. The second battery includes a second anode, a second cathode, a second separator, and a second electrolyte in a second pouch. The second pouch comprises a polymer coated with a conductive material and at least a second sealed and folded edge. The at least a second sealed and folded edge is folded in a single-side fold arrangement such that the at least a second sealed and folded edge substantially conforms to at least a portion of one surface of the second battery. The first battery is arranged proximate to the second battery to form a combined battery configuration. The combined battery configuration is wrapped with a pack wrap to form the battery system and to cover exposed conductive material in the sealed and folded edges of both the first battery and the second battery.

In an aspect, a mobile device is provided. The mobile device includes an application processor, a memory storage device, and at least one wrapped battery. The at least one wrapped battery includes an anode, a cathode, a separator, and an electrolyte. The at least one wrapped battery also includes a pouch comprising a polymer coated with a conductive material and at least one sealed and folded edge. The anode, the cathode, the separator, and the electrolyte are packaged within the pouch. The at least one sealed and folded edge is folded in a single-side fold arrangement to form a battery, such that the at least one sealed and folded edge substantially conforms to at least a portion of one surface of the battery. The battery is wrapped with a pack wrap to form the at least one wrapped battery and cover exposed conductive material on the at least one sealed and folded edge.

In an aspect, a method of sealing a battery is provided. The method includes providing a battery comprising an anode, a cathode, a separator, and an electrolyte in a pouch. The pouch includes a polymer coated with a conductive material and at least one sealed and folded edge. The at least one sealed and folded edge is folded in a single-side fold arrangement such that the at least one sealed and folded edge substantially conforms to at least a portion of a surface of the battery. The method also includes wrapping the battery in a pack wrap. The pack wrap covers exposed conductive material in the at least one sealed and folded edge.

In an aspect, a method of manufacturing a battery system is provided. The method includes providing a first battery comprising a first anode, a first cathode, a first separator, and a first electrolyte in a first pouch. The first pouch includes a polymer coated with a conductive material and at least a first sealed and folded edge. The at least a first sealed and folded edge is folded in a single-side fold arrangement such that the at least one sealed and folded edge substantially conforms to at least a portion of one surface of the first battery. The method also includes providing a second battery comprising a second anode, a second cathode, a second separator, and a second electrolyte in a second pouch. The second pouch includes a polymer coated with a conductive material and at least a second sealed and folded edge, and wherein the edge is folded in a single-side fold arrangement such that the at least one sealed and folded edge substantially conforms to at least a portion of one surface of the second battery. The method also includes arranging the first battery proximate to the second battery to form a combined battery configuration. The method also includes wrapping the combined battery configuration in a pack wrap to form the battery system. The pack wrap covers exposed conductive material in the sealed and folded edges of both the first battery and the second battery.

In an aspect, a method of manufacturing a battery is provided. The method includes, forming an anode, forming a cathode, and providing a separator. The anode, the cathode, and the separator are disposed in a layer arrangement. The method also includes winding the layered arrangement to form a wound arrangement, compressing the wound arrangement, and packing the wound arrangement in a pouch to form a battery. The method also includes soaking at least the wound arrangement in an electrolyte for a predetermined time at a predetermined temperature. The method further includes charging the battery via a plurality of charge cycles, subsequent to each charge cycle, discharging the battery via a plurality of discharge cycles, and in response to completing a respective charge cycle or a respective discharge cycle, providing a rest phase. The method also includes degassing the battery under a vacuum for a degas duration. The method further includes sealing at least one open edge to form at least one sealed edge and performing single-side folding on the at least one sealed edge to form at the least one sealed and folded edge. The method also includes providing the battery to a packaging vendor. The method does not include providing a side tape over the at least one sealed and folded edge.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 illustrates a battery, according to an example embodiment.

FIG. 2 illustrates a battery, according to the prior art.

FIG. 3 illustrates a battery, according to the prior art.

FIG. 4A illustrates a battery, according to an example embodiment.

FIG. 4B illustrates a battery, according to an example embodiment.

FIG. 4C illustrates a battery, according to an example embodiment.

FIG. 5 illustrates a portion of a pouch, according to an example embodiment.

FIG. 6A illustrates a battery system according to an example embodiment.

FIG. 6B illustrates a battery system, according to an example embodiment.

FIG. 7 illustrates a method, according to an example embodiment.

FIG. 8 illustrates a method, according to an example embodiment.

FIG. 9 illustrates a method, according to an example embodiment.

### DETAILED DESCRIPTION

### I. Overview

The present disclosure relates to batteries (e.g., lithium-ion cells) and methods of sealing and manufacturing such batteries and battery systems. Namely, the method includes a single-side folding process, which may be performed after initial battery cell formation. In example embodiments, the method can be used for a double battery cell design, wherein two batteries are arranged proximate to each other and wrapped together.

The method of manufacturing a battery generally includes forming an anode, forming a cathode, and providing a separator. In example embodiments, one or more batteries may be formed in a jelly-roll configuration. Specifically, the anode, cathode, and a separator may be disposed in a layered arrangement. The layered arrangement may be wound so as to form the jelly-roll configuration. The jelly-roll configuration may be compressed under increased heat and packaged in a pouch-type cell. In some embodiments, the pouch material may be made of layers of aluminized polypropylene, although it will be understood that other pouch materials are contemplated. For example, other types of aluminized materials and/or insulating materials coated with one or more conductive materials are contemplated and possible. The jelly-roll configuration or wound arrangement is then soaked in an electrolyte, the battery is charged and discharged, and the battery is degassed, thus forming the battery.

After the battery is formed, the pouch is sealed. Open sides of the pouch are pressure- and/or heat-sealed and then folded in a single-side fold on each edge. The single-side fold results in conductive layers of the pouch being exposed and thus the possibility of shorting or corrosion. Thus, the conductive layers need to be covered.

The present disclosure describes a method sealing a battery pouch using single-side folding without a side tape. Instead of the side tape, a pack wrap acts to cover the exposed conductive material on the edges of the pouch and thus improve battery safety by reducing the risk of overheating, fire, and/or explosion. This configuration can also allow for increased battery capacity.

Challenges associated with the present method could include shipping the pouch without side tape from the cell vendor to the packaging vendor without damaging the battery and keeping the pack wrap in constant contact with the exposed aluminum layers (i.e., preventing delamination). Specialized carriers may be needed to ship the formed batteries from the cell vendor to the packaging vendor without damage.

For some applications, double cell battery packs are desired. These battery systems include at least two batteries arranged proximate to each other (e.g., stacked upon one another) and wrapped by a single pack wrap. The delamination issue is particularly relevant with respect to two cell designs. The two battery cells need to be aligned properly to keep the pack wrap in constant contact with the exposed conductive layers of both batteries.

In example embodiments, the height of the sealed and fold edge is a predetermined height relative to the height of a surface of the battery, for example, between about 30 percent and about 80 percent of the height of the surface of the battery or equal to the height of the surface of the battery minus about 0.1 mm or about 0.2 mm. Other heights are also contemplated.

### II. Example Batteries

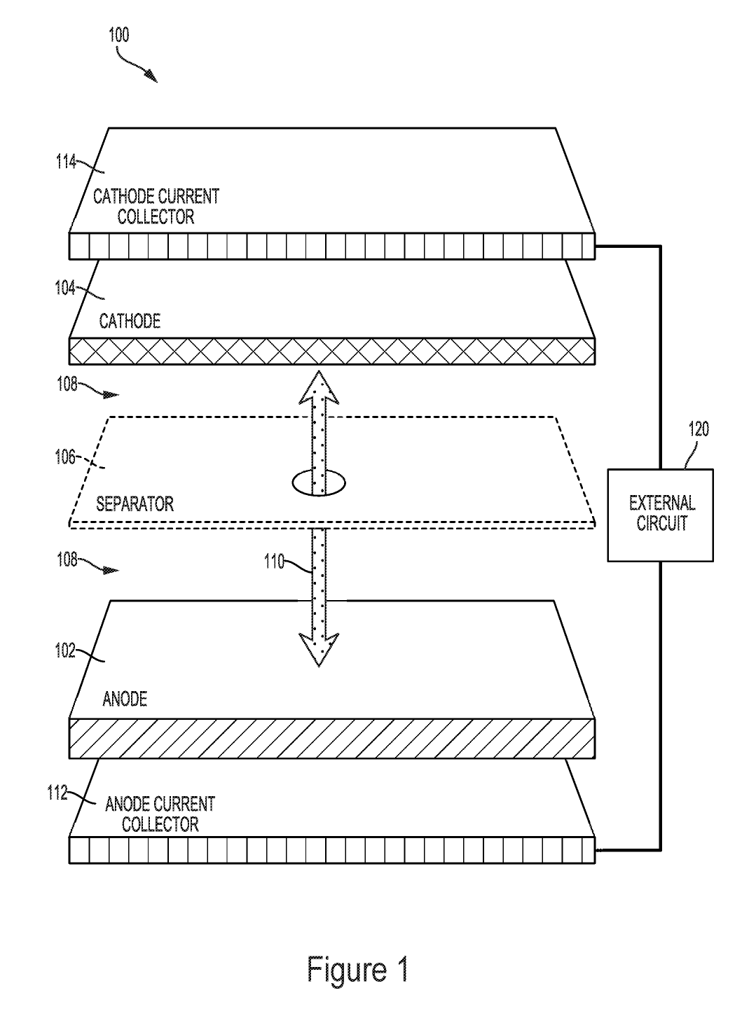

FIG. 1A illustrates a battery 100, according to an example embodiment. The battery 100 may include an anode 102, a cathode 104, and a separator 106. In some embodiments, the battery 100 may be a lithium-ion battery with thermal cut-off (TCO). In an example embodiment, the anode 102 may include silicon monoxide (SiO) or silicon. In other embodiments, the anode 102 may additionally or alternatively include lithium titanate (Li₄Ti₅O₁₂, or LTO) and/or an alloy of tin (e.g., Cu₆Sn₅) or cobalt (Co). The anode 102 may alternatively include carbonaceous materials such as hard carbon, soft carbon, graphite, or graphene. Some example embodiments may include nanoparticle forms of the anode materials described herein. Other materials are contemplated for the anode 102.

The cathode 104 may include a material such as lithium cobalt oxide (LiCoO₂, or LCO). Additionally or alternatively, the cathode 104 may include lithium manganese oxide (LiMn₂O₄, or LMO), lithium nickel manganese cobalt oxide (LiNiₓMn_{y}Co_{z}O₂, or NMC), or lithium iron phosphate (LiFePO₄, or LFP). Other cathode materials are possible. Furthermore, the cathode may be coated with aluminum oxide and/or another ceramic material, which may allow the battery to operate at higher voltages and/or provide other performance advantages.

In example embodiments, LCO and other cathode materials described herein may be deposited using various techniques such as RF sputtering or physical vapor deposition (PVD). However other deposition techniques may be used to form the cathode 104. The deposition of the cathode 104 may occur as a blanket over the entire substrate. A subtractive process of masking and etching may remove cathode material where unwanted. Additionally or alternatively, the deposition of the cathode 104 may be masked using a photolithography-defined resist mask.

The separator 106 may include a material configured to maintain a physical and electrical separation between the anode 102 and the cathode 104. The separator 106 may be a microporous membrane that is permeable to charge carriers (e.g., lithium ions) passing between the anode 102 and cathode 104, as shown in arrow 110. That is, the separator 106 may provide a physical barrier to prevent an electrical short while allowing reversible lithium ion transport between the anode 102 and the cathode 104.

In an example embodiment, the separator 106 may include one or more layers of a polymer-containing material (e.g., a polyolefin) such as polypropylene (PP), polyethylene (PE), or polymethylmethacrylate (PMMA), or a combination of such materials.

The electrolyte 108 of battery 100 may be arranged in and/or around the separator 106, and/or may be generally disposed between the anode 102 and the cathode 104. The electrolyte 108 may be configured to permit lithium ion conduction. Namely, electrolyte 108 may be configured to reversibly transport lithium ions via diffusion between the anode 102 and the cathode 104.

Further, the electrolyte 108 may take the form of or include a liquid electrolyte in a salt/solvent solution. The salt/solvent solution may include a lithium salt such as lithium hexafluorophosphate LiPF₆ or lithium tetrafluoroborate (LiBF₄). The lithium salt may be dissolved in an organic solvent such as ethylene carbonate (EC), dimethyl carbonate (DMC), and/or diethyl carbonate (DEC). Other electrolyte materials are possible. In an example electrolyte 108, a lithium salt may be incorporated or dissolved in the solvent with various molar concentrations. The electrolyte 108 may also include one or more additives.

The battery 100 may additionally include an anode current collector 112 and/or a cathode current collector 114. In an example embodiment, the anode current collector 112 and the cathode current collector 114 may include one or more materials that function as electrical conductors. Furthermore, the anode current collector 112 and the cathode current collector 114 may be configured to be block lithium ions and various oxidation products (H₂O, O₂, N₂, etc.).

In some embodiments, the anode current collector 112 and the cathode current collector 114 may include materials that have minimal reactivity with lithium. For example, the anode current collector 112 and/or the cathode current collector 114 may include one or more of: Au, Ag, Al, Cu, Co, Ni, Pd, Zn, and Pt. Alloys of such materials are also contemplated herein. In some embodiments, an adhesion layer material, such as Ti, may be included in the anode current collector 112 and/or the cathode current collector 114. In other words, the anode current collector 112 and/or the cathode current collector 114 may include multiple layers, e.g., TiPtAu. Other materials are possible to form the respective current collectors. For example, the anode current collector 112 and/or the cathode current collector 114 may be formed from carbon nanotubes and/or metal nanowires.

In an example embodiment, the anode current collector 112 and the cathode current collector 114 may be operable to be electrically coupled to an external circuit 120. That is, the battery 100 may generally provide power to the external circuit 120. In some cases, such as while charging battery 100, external circuit 120 may provide power to battery 100 so as to recharge it.

The external circuit 120 may include an electronic device, such as a computer, a laptop, a smartphone, a wearable device, a smartwatch, a tablet, an electric car, an electrical grid, or a mobile computing device. Generally, the external circuit 120 may include one or more devices that consume electrical power provided by the battery 100. Additionally, as described above, the external circuit 120 may include a charging device configured to recharge battery 100.

The anode 102, the cathode 104, the separator 106 and, optionally, the anode current collector 112 and the cathode current collector 114, may be disposed in a layered arrangement. In other words, the anode 102, the cathode 104, the separator 106, etc., may be layered or stacked on one another. The layered arrangement may be wound so as to form a wound configuration, which may be termed a “jelly-roll”. As an example, the layered arrangement may be wound into a substantially cylindrical shape as may be formed a roll-to-roll manufacturing method. In some embodiments, the layered arrangement may be wound around a shaped form. Shaped forms may include a rectangular card, a cylinder, or another forms configured to provide a shape and/or structural support for the wound arrangement. Shaped forms may include an insulating polymeric material such as polyethylene.

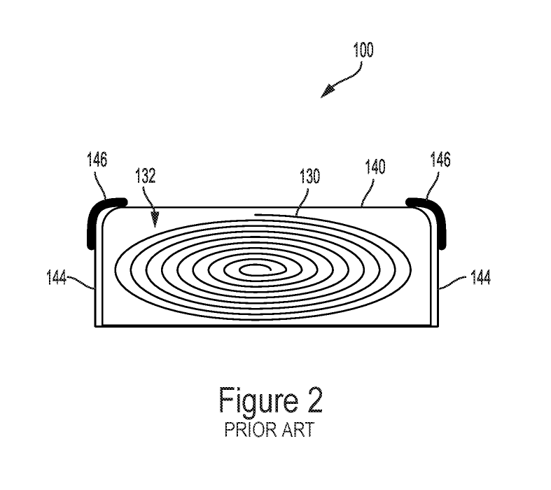

FIG. 2 illustrates a conventional battery 100, with a single-sidle fold arrangement and side tape. As illustrated in FIG. 2A, the wound arrangement 130 (e.g., the jelly-roll configuration) may be inserted or otherwise packaged within a pouch 140. The pouch 140 may include a polymer with a conductive coating. In some embodiments, the pouch 140 may include a layer of aluminum glued between layers of polymers. In some embodiments, the pouch 140 may be made of layers of aluminized polypropylene. In other embodiments, the pouch 140 may include aluminum with layers of nylon and/or polypropylene. In such an embodiment, the nylon layer may be the outer layer of the pouch 140 and the polypropylene layer may be the inner layer of the pouch 140. Other types of aluminized materials and/or insulating materials coated with one or more conductive materials are contemplated and possible.

The pouch may include one or more electrical feedthroughs (not shown) to provide electrical connections to the anode current collector 112 and the cathode current collector 114. In an example embodiment, the pouch 140 may be pressure- and/or heat-sealed on one or more edges 144 so as to enclose, package, and protect the battery 100. The pouch 140 may be sealed along at least one edge 144 of the pouch 140. At least initially, the pouch 140 may be configured to remain open so as to receive an electrolyte 132.

In the single-side fold arrangement, edges 144 are folded such that the edge substantially conforms to at least a portion of one surface of the battery 100. The single-side fold arrangement results in exposed conductive material. In the conventional arrangement in FIG. 2, the exposed conductive material may be covered with side tape 146 to reduce the risk of overheating, fire, and/or explosion. In some embodiments, the side tape may include acrylic adhesive with a polyethylene terephthalate (PET) or polyimide (PI) film. The thickness of the side tape may be approximately 0.05 mm, thus increasing the dimensions of the battery 100 or resulting in reduced battery capacity. For example, if the side tape is about 0.05 mm thick, in order to maintain the same battery size, the size of the wound arrangement would have to be reduced by about 0.1 mm to account for the side tape on the side and top of the battery, thus reducing the battery capacity.

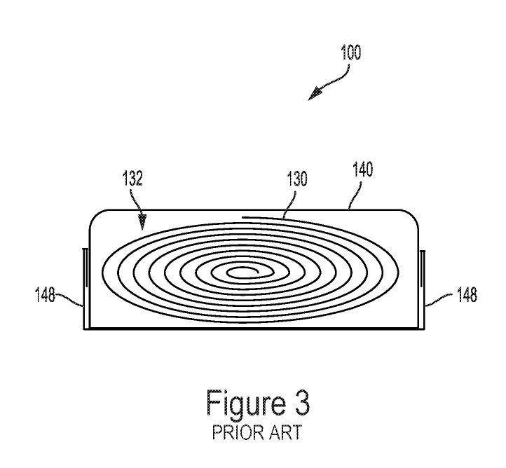

FIG. 3 illustrates a conventional battery 100, with a double-side fold arrangement. As discussed above, an alternative to single-side folding is double-side folding, wherein edges 148 are folded such that the edge substantially conforms to at least a portion of one surface of the battery. The edge with exposed conductive material is then again folded inward toward the battery surface prevent exposure of the conductive material layers. However, conventional double-side folding is a more complex closing process than single-side folding. In addition, double-side folding can increase the width of the battery 100, reducing the usable battery volume, and thus reducing battery capacity.

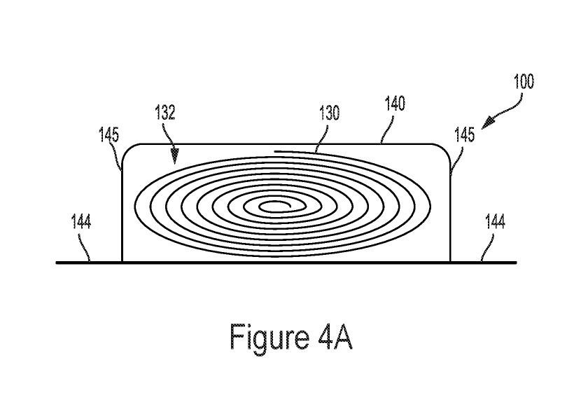

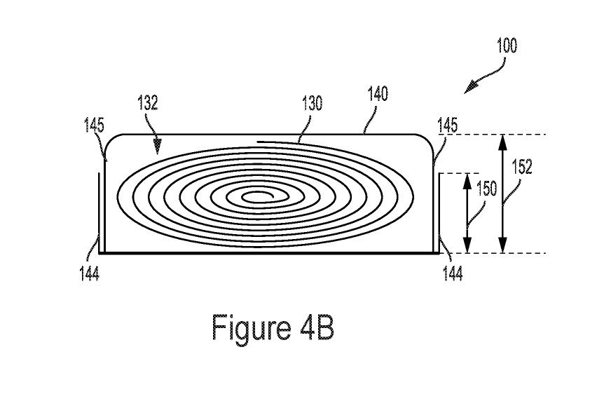

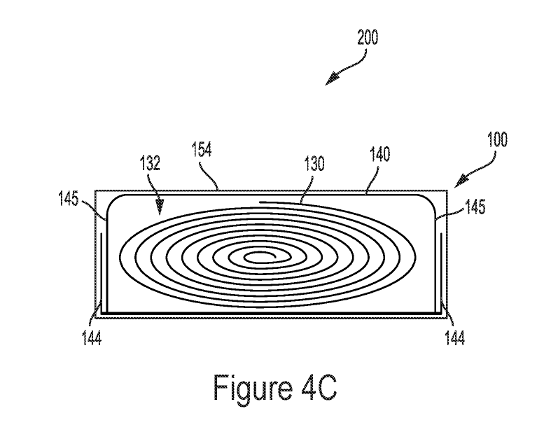

FIGS. 4A-4C illustrate a battery 100 during different steps in the battery sealing process, according to an example embodiment. Various steps of the battery formation and battery packaging could take place at a cell vendor and/or a packaging vendor. In an example embodiment, the battery is formed at the cell vendor, provided to a packaging vendor, and wrapped with a pack wrap at the packaging vendor.

The embodiment shown in FIG. 4A illustrates sealed edges 144 of battery 100 before they are folded. As illustrated in FIG. 4A, the wound arrangement 130 (e.g., the jelly-roll configuration) may be inserted or otherwise packaged within a pouch 140. The pouch 140 may include a polymer with a conductive coating. In some embodiments, the pouch 140 may include a layer of aluminum glued between layers of polymers. In further embodiments, the pouch 140 may be made of layers of aluminized polypropylene. In other embodiments, the pouch 140 may include aluminum with layers of nylon and/or polypropylene. In such an embodiment, the nylon layer may be the outer layer of the pouch 140 and the polypropylene layer may be the inner layer of the pouch 140. Other types of aluminized materials and/or insulating materials coated with one or more conductive materials are contemplated and possible.

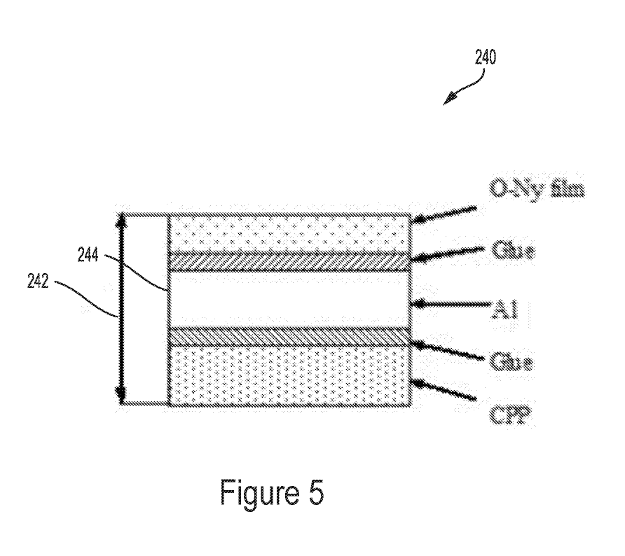

FIG. 5 shows a side view of a portion 240 of a pouch 140 with a thickness 242, according to any example embodiment. In some embodiments, the portion 240 may include a plurality of layers, such as a top nylon layer, a middle aluminum layer, and a bottom polypropylene layer, with glue in between the layers. Edge 244 may be uncovered after single-side folding, thus exposing conductive material. Each side of the pouch 140 may have a thickness 242 of between about 0.10 mm and about 0.15 mm. Other materials and sizes for the pouch 140 are contemplated and possible.

The pouch may include one or more electrical feedthroughs (not shown) to provide electrical connections to the anode current collector 112 and the cathode current collector 114. In an example embodiment, the pouch 140 may be pressure- and/or heat-sealed on edges 144 so as to enclose, package, and protect the battery 100. The pouch 140 may be sealed along edges 144 of the pouch 140. At least initially, the pouch 140 may be configured to remain open so as to receive an electrolyte 132.

The embodiment shown in FIG. 4B illustrates sealed edges 144 folded in a single-side fold arrangement, such that the at least one sealed and folded edge 144 substantially conforms to at least a portion of one surface of the battery. In an example embodiment, the edge 144 is folded at about a 90 degree angle to substantially conform to a side surface 145 of the battery 100. In some embodiments, the sealed and folded edge 144 may be substantially parallel to the side surface 145. Other configurations are also contemplated. In the single-side fold arrangement, conductive material of the sealed and folded edge 144 can be at least partially exposed.

In an example embodiment, a height 150 of the sealed and folded edge 144 may be a predetermined percentage of a height 152 of the side surface 145 of the battery 100. In certain embodiments, the height 150 of the edge 144 may be between about 30 percent and about 80 percent, between about 35 percent and about 80 percent, between about 40 percent and about 80 percent, between about 45 percent and about 80 percent, between about 50 percent and about 80 percent, between about 30 percent and about 75 percent, between about 30 percent and about 70 percent, between about 30 percent and about 65 percent, between about 30 percent and about 60 percent, between about 30 percent and about 55 percent, between about 35 percent and about 75 percent, between about 40 percent and about 70 percent, between about 45 percent and about 65 percent, or between about 50 percent and about 60 percent of the height 152 of the side surface 145.

In some embodiments, the height 150 of the edge 144 may be equal to the height 152 of the side surface 145 minus a predetermined amount. In certain embodiments, the height 150 of the edge 144 may be equal to the height 152 of the side surface 145 minus about 0.1 mm, about 0.2 mm, about 0.3 mm, about 0.4 mm, about 0.5 mm, about 0.6 mm, about 0.7 mm, about 0.8 mm, about 0.9 mm, or about 1.0 mm.

The embodiment shown in FIG. 4C illustrates the battery 100 after it has been wrapped with a pack wrap 154. In an example embodiment, the unwrapped battery 100 shown in FIG. 4B is shipped from a cell vendor to a packaging vendor in order to apply pack wrap 154. Specialized shipping materials may be needed to prevent damage of the battery 100 when it is shipped to the packaging vendor, as the battery 100 does not include side tape.

Pack wrap 154 may surround the entire battery 100 to form a wrapped battery 200 and thus cover exposed conductive material in edges 144. In an example embodiment, pack wrap 154 may include heat-resistant polyester. For example, the pack wrap 154 may include biaxially-oriented polyethylene terephthalate (boPET) tape or film. Other materials are contemplated for the pack wrap 154. In some embodiments, the pack wrap 154 may include a plurality of pieces arranged to cover substantially the entire surface of battery 100. Contrary to conventional batteries, the wrapped battery 200 in FIG. 4C does not include side tape over the exposed conductive material of the sealed and folded edges 144.

In some embodiments, the dimensions of the battery 100 (without the pack wrap) may be approximately 46-48 mm×26-28 mm×5-6 mm, however, other sizes are possible. As a result of outgassing during an initial cell formation process, a thickness of the battery 100 may expand. In an example embodiment, the thickness of the battery may expand from about 5.3 mm to about 5.9 mm. In some embodiments, the pack wrap 154 may have a thickness of between about 0.20 mm and about 0.30 mm.

It should be understood that FIGS. 4A-4C illustrate the battery 100 and the wrapped battery 200 in a “single cell” configuration and that other configurations are possible. For example, the battery 100 may be connected in a parallel and/or series configuration with similar or different batteries or circuits. In other words, several instances of battery 100 may be connected in series to in an effort to increase the open circuit voltage of the battery, for instance. Similarly, several instances of battery 100 may be connected in parallel to increase capacity (amp hours). In other embodiments, battery 100 may be connected in configurations involving other batteries. In an example embodiment, a plurality of instances of battery 100 may be configured in a planar array on the substrate. Battery 100 may also be arranged in a thin film-type configuration. Other arrangements and configurations are possible.

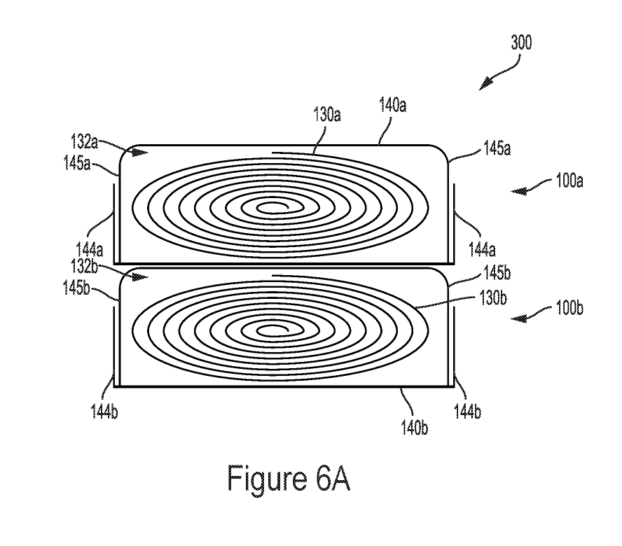

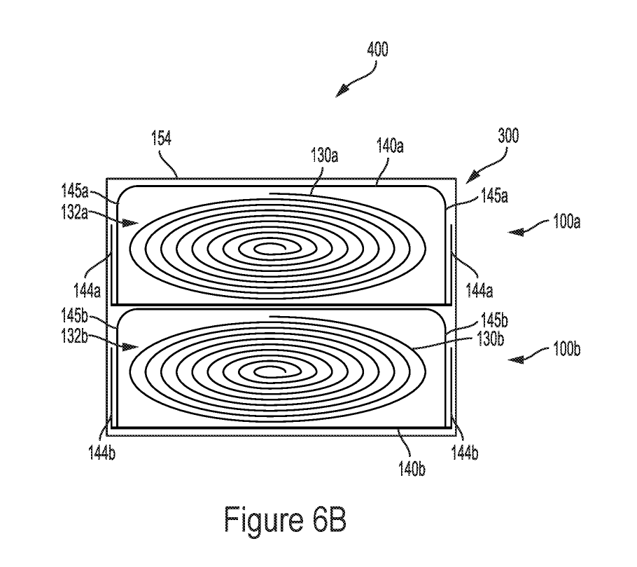

FIG. 6A illustrates a double cell battery system 300, according to an example embodiment. The battery system 300 may include a first battery 100a comprising a first anode, a first cathode, and a first separator, which may be formed into a first wound arrangement 130a, and a first electrolyte 132a in a first pouch 140a, and a second battery 100b comprising a second anode, a second cathode, and a second separator, which may be formed into a second wound arrangement 130b, and a second electrolyte 132b in a second pouch 140b. The first pouch 140a and the second pouch 140b may comprise a polymer coated with a conductive material. In some embodiments, the pouches 140a and 140b may include a layer of aluminum glued between layers of polymers. In other embodiments, the pouches 140a and 140b may include aluminum with layers of nylon and/or polypropylene. In such an embodiment, the nylon layer may be the outer layer of the pouches 140a and 140b and the polypropylene layer may be the inner layer of the pouches 140a and 140b. In some embodiments, the pouches 140a and 140b may be made of layers of aluminized polypropylene. Other types of aluminized materials and/or insulating materials coated with one or more conductive materials are contemplated and possible.

FIG. 5 shows a side view of a portion 240 of a pouch (such as pouch 140a or 140b) with a thickness 242, according to any example embodiment. In some embodiments, the portion 240 may include a plurality of layers, such as a top nylon layer, a middle aluminum layer, and a bottom polypropylene layer, with glue in between the layers. Edge 244 may be uncovered after single-side folding, thus exposing conductive material. Each side of the pouch 140a or 140b may have a thickness 242 of between about 0.10 mm and about 0.15 mm. Other materials and sizes for the pouches 140a and 140b are contemplated and possible.

In some embodiments, the first pouch 140a and the second pouch 140b may include at least a first edge 144a and at least a second edge 144b, respectively. Edges 144a and 144b may be folded in a single-side fold arrangement, such that each of the edges 144a and 144b substantially conforms to at least a portion of one surface of the batteries 100a and 100b. In an example embodiment, the edge 144a or 144b is folded at about a 90 degree angle to substantially conform to a side surface 145a or 145b of the battery 100a or 100b. In some embodiments, the sealed and folded edge 144a or 144b may be substantially parallel to the side surface 145a or 145b. Other configurations are also contemplated. In the single-side fold arrangement, conductive material of the sealed and folded edge 144a or 144b can be at least partially exposed.

In example embodiments, the first battery 100a may be arranged proximate to the second battery 100b to form a combined battery configuration. In some embodiments, the first battery 100a and the second battery 100b may be arranged in a stacked configuration, wherein the first battery 100a is arranged on top of the second battery 100b. In other embodiments, the first battery 100a and the second battery 100b may be arranged in a side by side configuration.

In further embodiments, the first battery 100a and the second battery 100b may be arranged such that the first and second sealed and folded edges 144a and 144b are folded in the same direction such that the exposed conductive material of the first sealed and folded edge 144a is located near a top surface of the combined battery configuration 300 and the exposed conductive material of the second sealed and folded edge 144b is located near the middle of the combined battery configuration 300, as shown in FIG. 6A. In other embodiments, the first battery 100a and the second battery 100b may be arranged such that the first and second sealed and folded edges 144a and 144b are folded in opposite directions such that the exposed conductive material of the first sealed and folded edge 144a is located near a top surface of the combined battery configuration 300 and the exposed conductive material of the second sealed and folded edge 144b is located near a bottom surface of the combined battery configuration 300 or such that the exposed conductive material of both the first sealed and folded edge 144a and the second sealed and folded edge 144b is located near the middle of the combined battery configuration 300.

The embodiment shown in FIG. 6B illustrates the combined battery configuration 300 after it has been wrapped with a pack wrap 154. The first battery 100a and the second battery 100b are arranged proximate to each other and wrapped with a pack wrap 154 to form the battery system 400 and to cover exposed conductive material on sealed and folded edges 144a and 144b. In some embodiments, the first battery 100a and the second battery 100b may be connected with tape or welded together before being wrapped with the pack wrap 154. In example embodiments, a pressure sensitive adhesive may be provided between the first battery 100a and the second battery 100b to connect the batteries. In some embodiments, in order to prevent delamination and fully cover the exposed conductive material, the first battery 100a and the second battery 100b may arranged such that the respective positions of the first battery 100a and the second battery 100b are substantially the same, as shown in FIGS. 6A and 6B.

Pack wrap 154 may surround the entire combined battery configuration 300 to form the battery system 400 and thus cover exposed conductive material in edges 144a and 144b. In an example embodiment, pack wrap 154 may include heat-resistant polyester. For example, the pack wrap 154 may include biaxially-oriented polyethylene terephthalate (boPET) tape or film. Other materials are contemplated for the pack wrap 154. In some embodiments, the pack wrap 154 may include a plurality of pieces arranged to cover substantially the entire surface of combined battery configuration 300. Contrary to conventional batteries, the combined battery configuration 300 in FIGS. 6A and 6B does not include side tape over the exposed conductive material of sealed and folded edges 144a and 144b.

In some embodiments, the dimensions of the battery system 400 may be approximately 46-51 mm×26-28 mm×11-13 mm after adding the pack wrap. The pack wrap may have a thickness of between about 0.2 mm to about 0.3 mm. As a result of outgassing during an initial cell formation process, a thickness of the first battery 100a and the second battery 100b may expand. In an example embodiment, the thickness of the battery may expand from about 11.3 to about 12.4 mm.

In some embodiments, the wrapped battery 200 or battery system 400 may be used in a mobile device. In example embodiments, the mobile device may include an application processor, a memory storage device, and a wrapped battery (such as the wrapped battery 200 in FIG. 4C) or a wrapped battery system (such as the battery system 400 in FIG. 6B).

### III. Example Methods

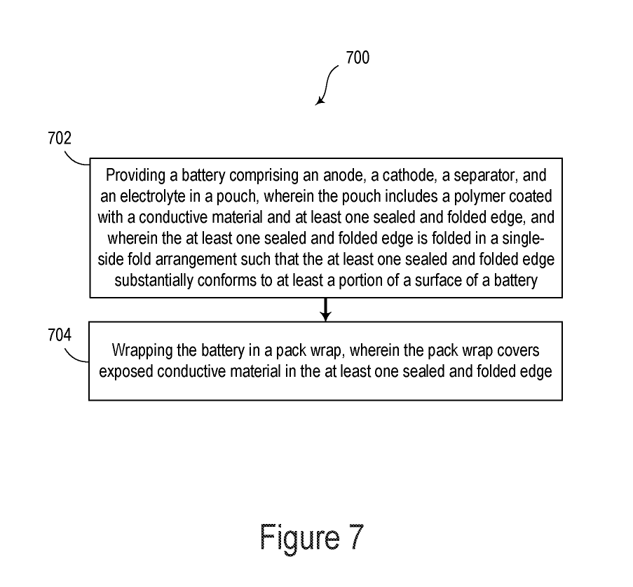

FIG. 7 illustrates a method 700, according to an example embodiment. The blocks of method 700 may be carried out to seal the battery 100. The method 700 may include various blocks or steps. The blocks or steps may be carried out individually or in combination. The blocks or steps may be carried out in any order and/or in series or in parallel. Further, blocks or steps may be omitted or added to method 700.

Block 702 includes providing a battery comprising an anode, a cathode, a separator, and an electrolyte in a pouch. The battery may be similar to or identical to battery 100, as illustrated and described in references to FIGS. 4A-4C. The pouch may be similar to or identical to pouch 140 and may comprise a polymer coated with a conductive material and at least one sealed and folded edge. The at least one sealed and folded edge may be folded in a single-side fold arrangement such that the at least one sealed and folded edge substantially conforms to at least a portion of one surface of the battery. In some embodiments, the battery may be manufactured at a cell vendor and then shipped and provided to a packaging vendor.

Block 704 includes wrapping the battery in a pack wrap. The pack wrap may be similar or identical to pack wrap 154 and may include heat-resistant polyester. For example, the pack wrap 154 may include biaxially-oriented polyethylene terephthalate (boPET) tape or film. The pack wrap may cover exposed conductive material in the at least one sealed and folded edge. In some embodiments, block 704 may be performed at a packaging vendor.

In example embodiments, method 700 does not include providing a side tape over the exposed conductive material of the at least one sealed and folded edge.

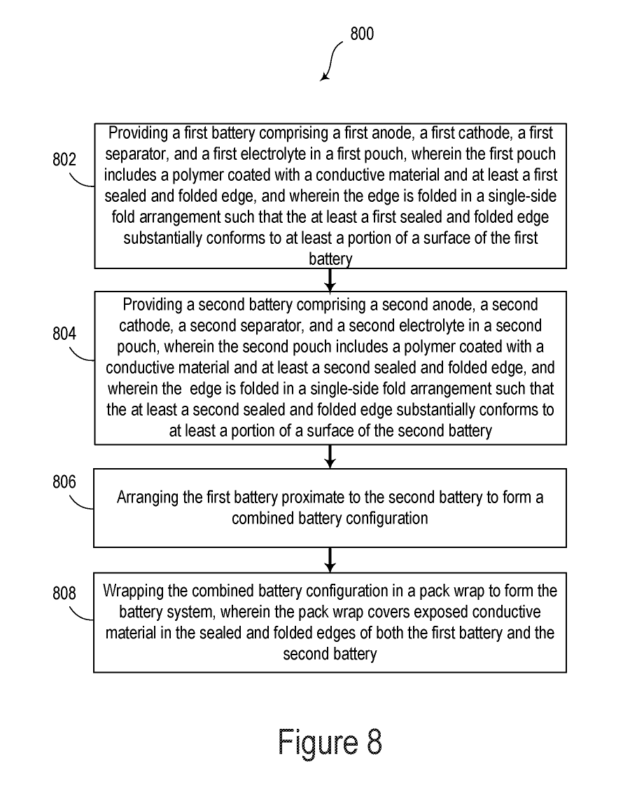

FIG. 8 illustrates a method 800, according to an example embodiment. The blocks of method 800 may be carried out to manufacture a battery system 400. The method 800 may include various blocks or steps. The blocks or steps may be carried out individually or in combination. The blocks or steps may be carried out in any order and/or in series or in parallel. Further, blocks or steps may be omitted or added to method 800.

Block 802 includes providing a first battery comprising a first anode, a first cathode, a first separator, and a first electrolyte in a first pouch, wherein the first pouch comprises a polymer coated with a conductive material and at least a first sealed and folded edge, and wherein the edge is folded in a single-side fold arrangement such that the at least a first sealed and folded edge substantially conforms to at least a portion of a surface of the first battery.

Block 804 includes providing a second battery comprising a second anode, a second cathode, a second separator, and a second electrolyte in a second pouch, wherein the second pouch comprises a polymer coated with a conductive material and at least a second sealed and folded edge, and wherein the edge is folded in a single-side fold arrangement such that the at least a second sealed and folded edge substantially conforms to at least a portion of a surface of the second battery.

Block 806 includes arranging the first battery proximate to the second battery to form a combined battery configuration.

Block 808 includes wrapping the combined battery configuration in a pack wrap to form the battery system, wherein the pack wrap covers exposed conductive material in the sealed and folded edges of both the first battery and the second battery.

In example embodiments, the method 800 does not include providing a side tape over the first sealed and folded edge and/or the second sealed and folded edge.

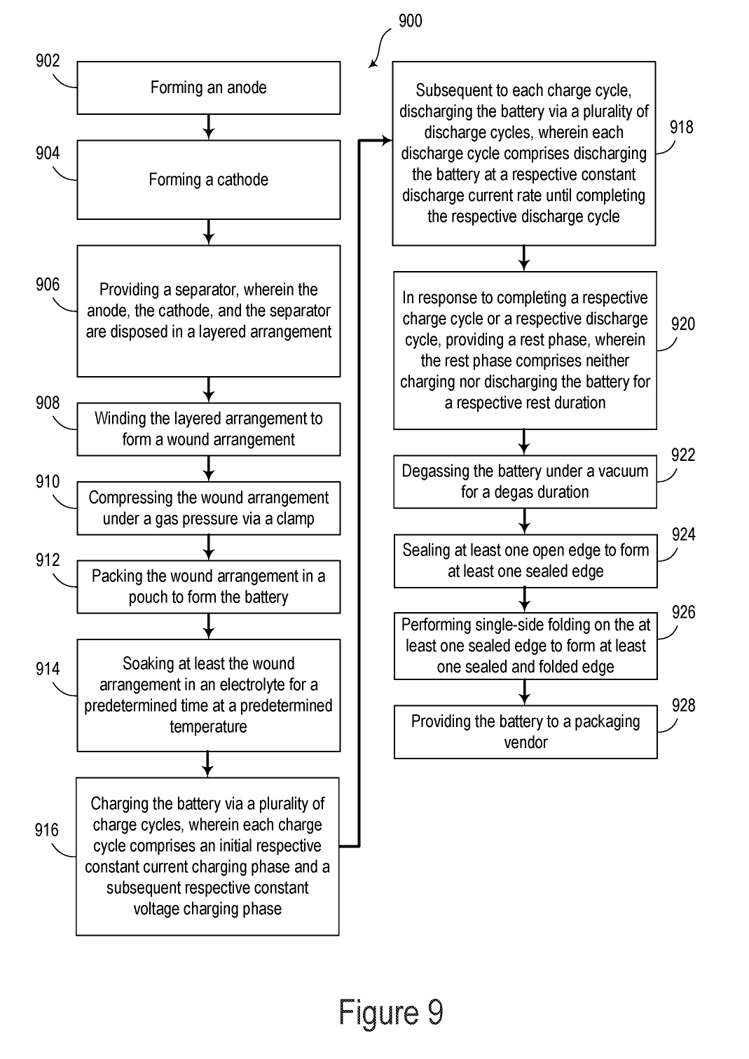

FIG. 9 illustrates a method 900, according to an example embodiment. The method 900 may include various blocks or steps. The blocks or steps may be carried out individually or in combination. The blocks or steps may be carried out in any order and/or in series or in parallel. Further, blocks or steps may be omitted or added to method 900.

The blocks of method 900 may be carried out to form or compose the elements of the battery 100 and/or the combined battery configuration 300, as illustrated and described in reference to FIGS. 4A-4C and 6A-6B. Additionally or alternatively, method 900 may include some or all of the method steps or blocks illustrated and described in reference to FIGS. 7 and 8.

Block 902 includes forming an anode. The anode could be similar or identical to anode 102 as illustrated and described in reference to FIG. 1.

Block 904 includes forming a cathode. The cathode may be similar or identical to the cathode 104 as illustrated and described in reference to FIG. 1.

Block 906 includes providing a separator. The separator of method 900 may be similar or identical to separator 106 as illustrated and described in reference to FIG. 1. In an example embodiment, the anode, cathode, and separator are disposed in a layered arrangement. In such a scenario, the separator may be incorporated into the layered arrangement via a roll-to-roll processing system.

Block 908 includes winding the layered arrangement to form a wound arrangement. The wound arrangement may include wrapping or winding the layered arrangement into a substantially cylindrical shape so as to resemble a “jelly-roll” configuration. For example, the layered arrangement may be wound around a spindle or a hub so as to form a substantially cylindrical “spiral” configuration.

Block 910 includes compressing the wound arrangement. The compression could be performed by a pneumatic clamp. In such a scenario, the pneumatic clamp may be configured to compress the wound arrangement via one or more compressed gas cylinders or pistons. In some embodiments, such a pressure or force may compress the wound arrangement into a substantially flat, rectangular shape. Other shapes are possible.

Block 912 includes packing the wound arrangement in a pouch to form a packaged battery. In an example embodiment, a robotic pick and place device may be configured to place the wound arrangement into an open pouch.

Block 914 includes soaking the wound arrangement in an electrolyte for a predetermined soak time and a predetermined soak temperature. While soaking, a temperature of the electrolyte and/or the wound arrangement may increase and the thickness of the packaged battery may increase. It will be understood that the expansion of the packaged battery may vary based on temperature, electrolyte composition, battery form factor, pouch volume, etc.

The electrolyte may be similar or identical to electrolyte 108 as illustrated and described in reference to FIG. 1.

A cell formation process may be carried out after the electrolyte soaking step(s). The cell formation process may include various charge, discharge, rest, and degas steps. In general, the cell formation process may include several charge cycles, each including a constant current (CC) charge phase followed by a constant voltage (CV) charge phase. In the embodiments described herein, a given charge cycle may include a larger CC charging rate (C rate) as compared to prior charge cycles.

Blocks 916, 918, 920, and 922 may generally describe the cell formation process, however other blocks relating to the cell formation process may be included. Furthermore, blocks may be repeated or omitted in some embodiments. Block 916 includes charging the battery via plurality of charge cycles. Each charge cycle includes an initial respective constant charge current charging phase and a subsequent respective constant voltage charging phase. In an example embodiment, the cell formation process may include four charge cycles. However, different numbers of charge cycles are contemplated.

Block 918 includes, subsequent to each charge cycle, discharging the battery via a plurality of discharge cycles. Each discharge cycle may include discharging the battery at a respective constant discharge current rate until completing the respective discharge cycle.

Block 920 includes, in response to completing a respective charge cycle or a respective discharge cycle, providing a rest phase. The rest phase includes neither charging nor discharging the battery for a respective rest duration.

Block 922 includes degassing the battery under a vacuum for a degas duration.

Block 924 includes sealing at least one open edge to form at least one sealed edge.

Block 926 includes performing single-side folding on the at least one sealed edge to form at least one sealed and folded edge. The at least one sealed and folded edge may be similar or identical to edges 144, 144a, or 144b as illustrated and described in reference to FIGS. 4A-4C or FIGS. 6A-6B.

Block 928 includes providing the battery to a packaging vendor.

In example embodiments, method 900 does not include providing a side tape over the exposed conductive material of the at least one sealed and folded edge.

In some embodiments, the method 900 may further include wrapping the battery with a pack wrap, wherein the pack wrap covers exposed conductive material of the at least one sealed and folded edge, such as set forth in method 700. In other embodiments, the method 900 may further include wrapping the combined battery configuration in a pack wrap to form the battery system, wherein the pack wrap covers exposed conductive material in the sealed and folded edges of both the first battery and the second battery, as set forth in method 900.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A wrapped battery comprising:
an anode,
a cathode,
a separator;
an electrolyte; and
a pouch comprising a polymer coated with a conductive material and at least one sealed and folded edge,
wherein the anode, the cathode, the separator, and the electrolyte are packaged within the pouch,
wherein the at least one sealed and folded edge is folded in a single-side fold arrangement to form a battery, such that the at least one sealed and folded edge substantially conforms to at least a portion of a surface of the battery, and
wherein the battery is wrapped with a pack wrap to form the wrapped battery and cover exposed conductive material on the at least one sealed and folded edge.

2. The wrapped battery of claim 1, wherein a height of the at least one sealed and folded edge is between about 30 percent and about 80 percent of a height of the surface of the battery.

3. The wrapped battery of claim 1, wherein a height of the at least one sealed and folded edge is between about 45 percent and about 65 percent of a height of the surface of the battery.

4. The wrapped battery of claim 1, wherein a height of the at least one sealed and folded edge is equal to a height of the surface of the battery minus about 0.1 mm.

5. The wrapped battery of claim 1, wherein a height of the at least one sealed and folded edge is equal to a height of the surface of the battery minus about 0.2 mm.

6. The wrapped battery of claim 1, further comprising at least an additional sealed and folded edge.

7. The wrapped battery of claim 1, wherein the anode, the cathode, and the separator are disposed in a layered arrangement.

8. The wrapped battery of claim 7, wherein the layered arrangement is wound so as to form a jelly-roll configuration.

9. The wrapped battery of claim 1, wherein the wrapped battery does not include side tape over the exposed conductive material of the at least one sealed and folded edge.

10. The wrapped battery of claim 1, wherein the exposed conductive material is an aluminized material.

11. A battery system comprising:
a first battery comprising a first anode, a first cathode, a first separator, and a first electrolyte in a first pouch, wherein the first pouch comprises a polymer coated with a conductive material and at least a first sealed and folded edge, and wherein the at least a first sealed and folded edge is folded in a single-side fold arrangement such that the at least a first sealed and folded edge substantially conforms to at least a portion of one surface of the first battery; and
a second battery comprising a second anode, a second cathode, a second separator, and a second electrolyte in a second pouch, wherein the second pouch comprises a polymer coated with a conductive material and at least a second sealed and folded edge, and wherein the at least a second sealed and folded edge is folded in a single-side fold arrangement such that the at least a second sealed and folded edge substantially conforms to at least a portion of one surface of the second battery;
wherein the first battery is arranged proximate to the second battery to form a combined battery configuration, and
wherein the combined battery configuration is wrapped with a pack wrap to form the battery system and to cover exposed conductive material in the sealed and folded edges of both the first battery and the second battery.

12. The battery system of claim 11, wherein the first battery and the second battery are arranged such respective positions of the first battery and the second battery are substantially the same.

13. The battery system of claim 11, wherein the first battery and the second battery are arranged in a stacked configuration.

14. The battery system of claim 11, wherein the first battery and the second battery are arranged in a side by side configuration.

15. The battery system of claim 11, wherein the battery system does not include side tape over the exposed conductive material of the first sealed and folded edge and the second sealed and folded edge.

16. The battery system of claim 11, wherein the exposed conductive material is an aluminized material.

17. A mobile device comprising:
an application processor;
a memory storage device; and
at least one wrapped battery, comprising:
an anode,
a cathode,
a separator;
an electrolyte; and
a pouch comprising a polymer coated with a conductive material and at least one sealed and folded edge,
wherein the anode, the cathode, the separator, and the electrolyte are packaged within the pouch,
wherein the at least one sealed and folded edge is folded in a single-side fold arrangement to form a battery, such that the at least one sealed and folded edge substantially conforms to at least a portion of one surface of the battery, and
wherein the battery is wrapped with a pack wrap to form the at least one wrapped battery and cover exposed conductive material on the at least one sealed and folded edge.

18. The mobile device of claim 17, wherein the wrapped battery does not include side tape over the exposed conductive material of the at least one sealed and folded edge.

19. A mobile device comprising:
an application processor;
a memory storage device; and
the battery system of claim 11.

20. The mobile device of claim 19, wherein the battery system does not include side tape over the exposed conductive material of the first sealed and folded edge and the second sealed and folded edge.
